(19) United States
(12) Patent Application Publication
(10) Pub. No.: US 2026/0289482 A1
(43) Pub. Date: Sep. 24, 2026

(54) SERVER AND METHOD FOR PROCESSING ON-DEMAND SERVICES

(71) Applicant: GRABTAXI HOLDINGS PTE. LTD., Singapore (SG)

(72) Inventor: Sai Mahadev BADINI, Bengaluru (IN)

(73) Assignee: GRABTAXI HOLDINGS PTE. LTD., Singapore, SG (SG)

(21) Appl. No.: 19/477,594

(22) PCT Filed: May 17, 2024
(86) PCT No.: PCT/SG2024/050325

§ 371 Date: Oct. 22, 2025

(30) Foreign Application Priority Data
Jun. 14, 2023 (SG) 10202301688P

(51) Int. Cl. G06Q 10/0832; G06Q 10/047

(52) U.S. Cl. CPC G06Q 10/0832; G06Q 10/047

(57) ABSTRACT

Aspects concern a server for processing on-demand services, comprising: a memory for storing instructions; and a processor for executing the stored instructions and configured to: receive a plurality of requests for an item delivery service, wherein each of the plurality of requests includes information about at least one selected item and a delivery location for the item delivery service; segment the requests into one or more batches based on time relating to each of the requests; for each of the batches, segment the requests into one or more geographical area groups based on the delivery location for each of the requests; and assign one or more vehicles capable of producing the selected item into the one or more geographical area groups, so that the assigned vehicle prepares the selected item for the item delivery service while the assigned vehicle moves along a travel route in a geographical area.

### TECHNICAL FIELD

Various embodiments relate to a server and a method for processing on-demand services.

### BACKGROUND

Due to development of information and communications technology, a user may request an on-demand service using a computing device. The on-demand service may allow the user to fulfil the user's demand via an immediate access to items and/or services. The user may request the on-demand service, such as a transport service or an item delivery service, using a user interface presented on the computing device.

However, there has been a need to achieve a fast (for example, real-time) item delivery service. For example, if an item should be consumed within a short period of time after producing the item (for example, a perishable grocery, food or medicine), the fast item delivery service may be needed. As another example, if an item should be kept in a certain environment (for example, in a freezer), the fast item delivery service may be needed to minimise exposure of the item to an outside environment.

Accordingly, there exists a need for providing an improved solution to achieve fast on-demand services.

### SUMMARY

In accordance with various embodiments, there is a server for processing on-demand services, the server comprising: a memory for storing instructions; and a processor for executing the stored instructions and configured to: receive a plurality of requests for an item delivery service, wherein each of the plurality of requests includes information about at least one selected item and a delivery location for the item delivery service; segment the requests into one or more batches based on time relating to each of the requests; for each of the batches, segment the requests into one or more geographical area groups based on the delivery location for each of the requests; and assign one or more vehicles capable of preparing the selected item to the one or more geographical arca groups, so that the assigned vehicle prepares the selected item for the item delivery service while the assigned vehicle moves along a travel route in a geographical area corresponding to the geographical area group that the vehicle is assigned.

In some embodiments, the processor is further configured to, for each of the geographical area groups, segment the requests into one or more clusters based on the selected item for each of the requests.

In some embodiments, the processor is further configured to, for each of the geographical arca groups, assign the one or more vehicles to the one or more clusters based on the vehicles' capabilities of preparing the selected item.

In some embodiments, the processor is further configured to: for each of the geographical arca groups, select a delivery service provider from one or more delivery service providers based on at least one of a geographical location of the delivery service provider, the geographical location of the assigned vehicle and the delivery location; and request the selected delivery service provider to pick up the selected item at a centre location on the assigned vehicle's travel route and deliver the selected item to the delivery location.

In some embodiments, the processor is further configured to determine the centre location on the travel route of the assigned vehicle, based on delivery locations for each of the requests belonging to the geographical area group.

In some embodiments, the processor is further configured to segment the requests into the one or more batches based on a predetermined time slot to which the time relating to each of the requests belongs.

In some embodiments, the processor is further configured to determine the predetermined time slot based on historical data about the requests for the item delivery service.

In some embodiments, the processor is further configured to, after the requests belonging to a first batch are processed, update the predetermined time slot based on a number of the requests and the vehicles' performance of preparing the selected item.

In some embodiments, the processor is further configured to, after a predetermined time for processing the requests belonging to a previous batch, check if the previous batch includes at least one request which is not processed; and include the request which is not processed in the previous batch into a next batch of the requests.

In accordance with various embodiments, there is a method for processing on-demand services, the method comprising: receiving a plurality of requests for an item delivery service, wherein each of the plurality of requests includes information about at least one selected item and a delivery location for the item delivery service; segmenting the requests into one or more batches based on time relating to each of the requests; for each of the batches, segmenting the requests into one or more geographical area groups based on the delivery location for each of the requests; and assigning one or more vehicles capable of preparing the selected item to the one or more geographical area groups, so that the assigned vehicle prepares the selected item for the item delivery service while the assigned vehicle moves along a travel route in a geographical area corresponding to the corresponding geographical area group that the vehicle is assigned.

In some embodiments, the method further comprises, for each of the geographical area groups, segmenting the requests into one or more clusters based on the selected item for each of the requests.

In some embodiments, the method further comprises, for each of the geographical area groups, assigning the one or more vehicles to the one or more clusters based on the vehicles' capabilities of preparing the selected item.

In some embodiments, the method further comprises, for each of the geographical area groups, selecting a delivery service provider from one or more delivery service providers based on at least one of a geographical location of the delivery service provider, the geographical location of the assigned vehicle and the delivery location; and requesting the selected delivery service provider to pick up the selected item at a centre location on the assigned vehicle's travel route and deliver the selected item to the delivery location.

In some embodiments, the method further comprises determining the centre location on the travel route of the assigned vehicle, based on delivery locations for each of the requests belonging to the geographical arca group.

In some embodiments, the method further comprises segmenting the requests into the one or more batches based on a predetermined time slot to which the time relating to each of the requests belongs.

In some embodiments, the method further comprises determining the predetermined time slot based on historical data about the requests for the item delivery service.

In some embodiments, the method further comprises, after the requests belonging to a first batch are processed, updating the predetermined time slot based on a number of the requests and the vehicles' performance of preparing the selected item.

In some embodiments, the method further comprises, after a predetermined time for processing the requests belonging to a previous batch, checking if the previous batch includes at least one request which is not processed; and including the request which is not processed in the previous batch into a next batch of the requests.

According to various embodiments, a data processing apparatus configured to perform the method of any one of the above embodiments is provided.

According to various embodiments, a computer program clement comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

According to various embodiments, there is a system for processing on-demand services. The system comprises one or more computing device each associated with one or more users; and one or more vehicles capable of preparing an item. The system further comprises a server comprising: a memory for storing instructions; and a processor for executing the stored instructions and configured to: receive a plurality of requests for an item delivery service from the computing devices, wherein each of the plurality of requests includes information about at least one selected item and a delivery location for the item delivery service; segment the requests into one or more batches based on time relating to each of the requests; for each of the batches, segment the requests into one or more geographical area groups based on the delivery location for each of the requests; and assign the one or more vehicles capable of preparing the selected item to the one or more geographical area groups, so that the assigned vehicle prepares the selected item for the item delivery service while the assigned vehicle moves along a travel route in a geographical area corresponding to the geographical arca group that the vehicle is assigned.

### BRIEF DESCRIPTION OF THE DRAWINGS

The invention will be better understood with reference to the detailed description when considered in conjunction with the non-limiting examples and the accompanying drawings, in which:

FIG. 1 illustrates an infrastructure of a system including a server for processing on-demand services according to various embodiments.

FIG. 2 illustrates a block diagram of a server for processing on-demand services according to various embodiments.

FIG. 3 illustrates a flow diagram for a method for processing on-demand services according to various embodiments.

FIG. 4 illustrates a block diagram of a vehicle for processing on-demand services according to various embodiments.

FIG. S illustrates a flow diagram for a method for processing on-demand services according to various embodiments.

FIG. 6 illustrates an exemplary diagram of tabulating data for an entire request stream according to various embodiments.

FIGS. 7 to 11 illustrate exemplary diagrams of segmenting requests for an on-demand service into one or more geographical area groups according to various embodiments.

FIGS. 12 to 15 illustrate exemplary diagrams of assigning vehicles to one or more geographical area groups according to various embodiments.

FIG. 16 illustrates exemplary diagrams of a user interface of a user's computing device according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized, and structural and logical changes may be made without departing from the scope of the disclosure. The various embodiments are not necessarily mutually exclusive, as some embodiments can be combined with one or more other embodiments to form new embodiments.

Embodiments described in the context of one of a server and a method are analogously valid for the other of the server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

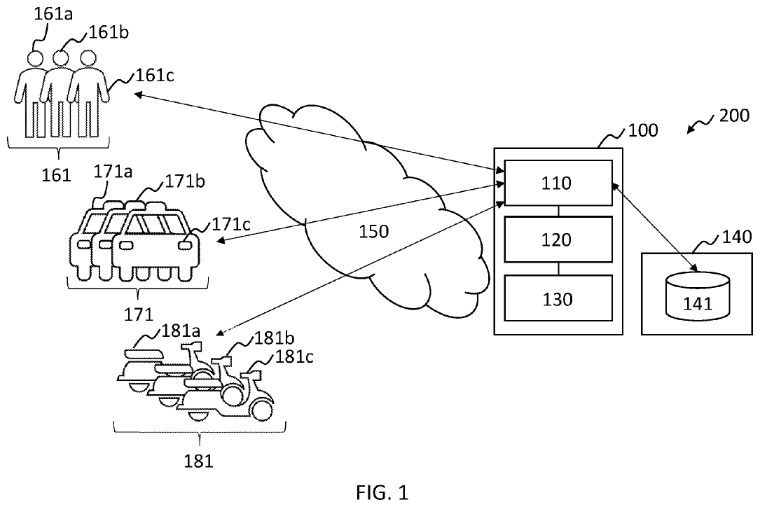

FIG. 1 illustrates an infrastructure of a system 200 including a server 100 for processing on-demand services according to various embodiments.

As shown in FIG. 1, the system 200 may include, but is not limited to, the server 100, a database system 140, a network 150, and one or more vehicles 171. The system 200 may further include one or more computing devices 160 (not shown) and one or more external devices 170, 180 (not shown).

In some embodiments, the on-demand service may be a service allowing a user 161 to fulfil the user's demand via an immediate access to items and/or services. The user 161 may request the on-demand service, such as a transport service or an item delivery service, using a user interface presented on the computing device 160.

In some embodiments, the server 100 may be used for the delivery of the item, for example, goods which may be prepared in a short while, for example, during transit of the vehicles 171, from its individual raw materials. In some embodiments, the vehicles 171 may include an item preparation unit to prepare the item. In some embodiments, the item preparation unit may be an encapsulated item preparation unit. In some embodiments, the server 100 may be used recursively to generate a (large scale) product at a final delivery destination. For example, a fleet of item preparation units of vehicles 171 may use initial raw materials to generate an intermediate product which may be delivered to another fleet of item preparation units of vehicles 171 and further processed and/or assembled into an order product by time it reaches the final delivery destination or a centre location (as will be described with reference to FIG. 5).

In some embodiments, the network 150 may include, but is not limited to, a Local Area Network (LAN), a Wide Area Network (WAN), a Global Area Network (GAN), or any combination thereof. The network 150 may provide a wireline communication, a wireless communication, or a combination of the wireline and wireless communication between the server 100 and the computing device 160, between the server 100 and the vehicle 171, and between the server 100 and the one or more external devices 170, 180, for example, one or more vehicle driver devices 170, and one or more delivery service provider devices 180.

In some embodiments, the computing device 160 may be connectable to the server 100 via the network 150. In some embodiments, the computing device 160 may be arranged in data or signal communication with the server 100 via the network 150. In some embodiments, the computing device 160 may include, but is not limited to, at least one of the following: a mobile phone, a tablet computer, a laptop computer, a desktop computer, a head-mounted display and a smart watch. In some embodiments, the computing device 160 may be associated with the user 161. For example, the computing device 160 may belong to the user 161. Although not shown, in some embodiments, the system 200 may further include a plurality of computing devices 160 each belonging to a plurality of users 161.

In some embodiments, the computing device 160 may include a location sensor. In some embodiments, the location sensor may communicate with at least one of a global positioning satellite (GPS) server, a network server, and a Wi-Fi server, to detect a location of the computing device 160. In some embodiments, the computing device 160 may generate information about the location of the computing device 160.

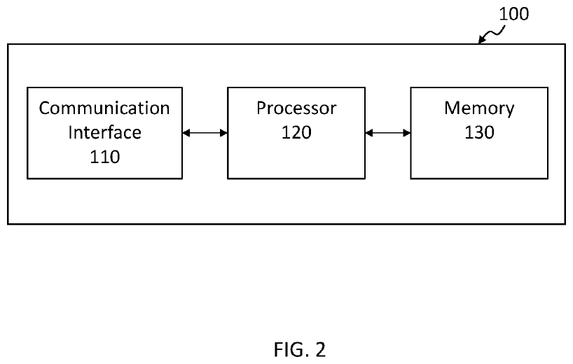

In some embodiments, the server 100, for example, implemented by a server computer, may include a communication interface 110, a processor 120, and a memory 130 (as will be described with reference to FIG. 2).

In some embodiments, the server 100 may communicate with the computing device 160 via the network 150. In some embodiments, the computing device 160 may receive a request from the user 161 for an on-demand service. The computing device 160 may send the request to the server 100 via the network 150. In some embodiments, the computing device 160 may send the information about the location of the computing device 160 to the server 100 via the network 150. The location of the computing device 160 may be considered as a location of the user 161.

In some embodiments, the system 200 may further include a database 141. In some embodiments, the database 141 may be a part of the database system 140 which may be external to the server 100. The server 100 may communicate with the database 141. In some other embodiments, although not shown, the database 141 may be implemented locally in the memory 130 of the server 100.

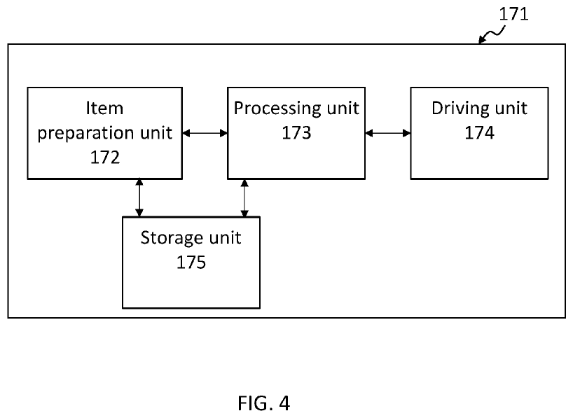

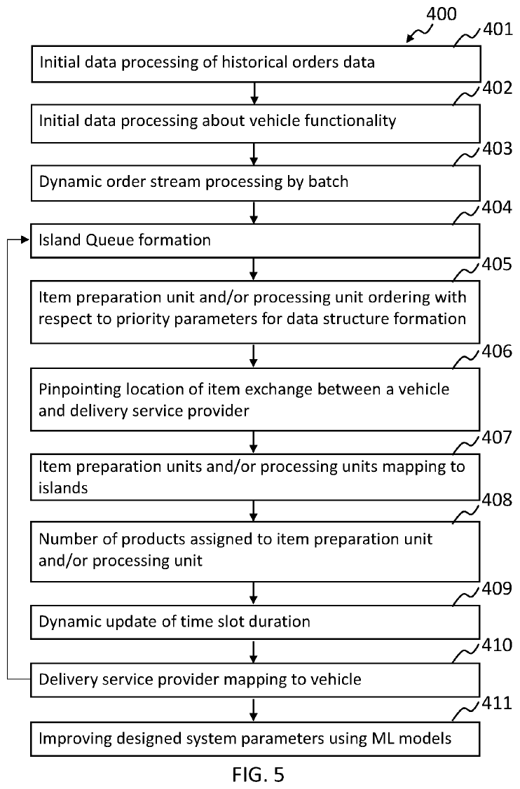

In some embodiments, the server 100 may communicate with the one or more external devices 170, for example, the one or more vehicle driver devices 170, via the network 150. The one or more vehicle driver devices 170 may be associated with one or more vehicles 171 respectively. The one or more vehicles 171 may be associated with one or more drivers (not shown) respectively. For example, a vehicle driver device 170 may belong to a driver of a respective vehicle 171. In some embodiments, the server 100 may communicate with the one or more vehicles 171, for example, a processing unit 173 of the vehicle 171, via the network 150 (as will be described with reference to FIG. 4). In some embodiments, the server 100 may communicate with the vehicle driver device 170 and the processing unit 173 of the vehicle 171 respectively. In some other embodiments, the server 100 may communicate with the vehicle driver device 170, and the vehicle driver device 170 may communicate with the processing unit 173 of the vehicle 171. In some other embodiments, the server 100 may communicate with the processing unit 173 of the vehicle 171, and the processing unit 173 of the vehicle 171 may communicate with the vehicle driver device 170.

The one or more vehicles 171 may provide items, for example, foods, (synthetic) medicines, groceries, or goods. The one or more vehicles 171 may be item providers. In some embodiments, the server 100 may receive a request for an item delivery service with information about at least one selected item and a delivery location for the item delivery service. For example, the request may be received from the computing device 160 of the user 161. In some embodiments, the server 100 may then produce a list of items, associated with the one or more vehicles 171 as one or more item providers, which can be prepared and delivered to a delivery service provider 181, so that the delivery service provider 181 may deliver the item to the user 161 within a certain estimated time of arrival. In some embodiments, the server 100 may then assign one of the vehicles 171, for example, a vehicle 171a, based on at least one of time relating to the request, the delivery location of the request, and the selected item. In some embodiments, the server 100 may communicate with the processing unit 173 of the one or more vehicles 171 to aggregate information including, but not limited to, a list of available items, an estimated time of preparation of each item, and an estimated price of each item, in order to produce the list of items. In some embodiments, the computing device 160 may display the list of items with the aggregated information of the at least one of the one or more vehicles 171 on the user interface. In some embodiments, after the user 161 makes selections on the user interface for the request for the item delivery service, for example, by selecting the item, the server 100 may communicate with a processing unit 173a of the vehicle 171a to prepare the selected item.

In some embodiments, the server 100 may communicate with the processing unit 173a of the vehicle 171a and/or the vehicle driver device 170a to aggregate information including, but not limited to, a location of the vehicle 171a and a direction in which the vehicle 171a is moving, in order to assign the vehicle 171a to prepare the selected item for the user 161. In some embodiments, the computing device 160 of the user 161 may display information of the assigned vehicle 171a with the aggregated information on the user interface. In some embodiments, the vehicle 171 may then prepare the selected item along a travel route of the vehicle 171 (as will be described with reference to FIG. 4). In some embodiments, the vehicle 171 may prepare the selected item before the vehicle 171 reaches to the centre location (as will be described with reference to FIG. 5).

In some embodiments, the server 100 may communicate with the one or more external devices 180, for example, the one or more delivery service provider devices 180, via the network 150. The one or more delivery service provider devices 180 may be associated with one or more delivery service providers 181 respectively. For example, the one or more delivery service provider devices 180 may belong to the one or more delivery service providers 181 respectively. The one or more delivery service providers 181 may include, but are not limited to, a delivery service provider, who can provide a delivery service from a first location, for example, the centre location, to a second location, for example, a selected delivery location such as the location of the user 161 or another location that the user 161 requested for the delivery. In some embodiments, after the user 161 makes selections for a request for an item delivery service, for example, by selecting an item, using the computing device 160, the server 100 may allocate at least one of the delivery service providers 181, for example, a delivery service provider 181a, to deliver the selected item from the assigned vehicle 171a to the selected delivery location.

FIG. 2 illustrates a block diagram of a server 100 for processing on-demand services according to various embodiments.

As shown in FIG. 2, the server 100, for example, implemented by a server computer, may include a communication interface 110, a processor 120, and a memory 130.

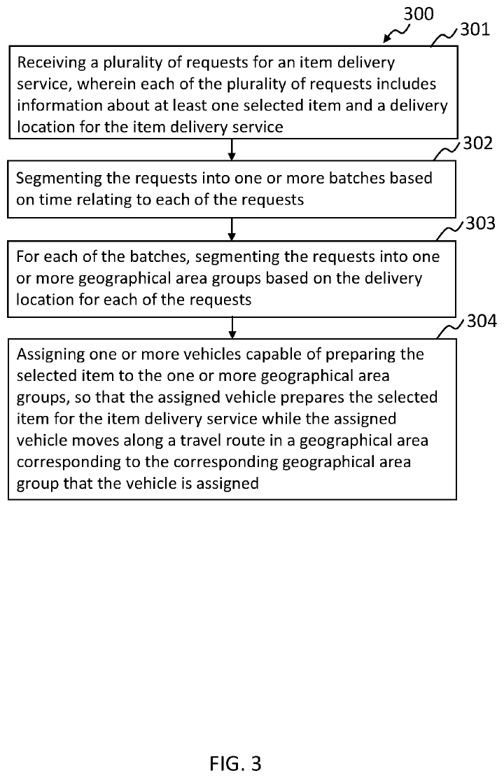

In some embodiments, the memory 130 (also referred to as a “database”) may store input data and/or output data temporarily or permanently. In some embodiments, the memory 130 may store program code which allows the server 100 to perform a method 300 (as will be described with reference to FIG. 3). In some embodiments, the program code may be embedded in a Software Development Kit (SDK). The memory 130 may include an internal memory of the server 100 and/or an external memory. The external memory may include, but is not limited to, an external storage medium, for example, a memory card, a flash drive, and a web storage.

In some embodiments, the communication interface 110 may allow one or more computing devices, including a computing device 160. to communicate with the processor 120 of the server 100 via a network 150, as shown in FIG. 1. In some embodiments, as shown in FIG. 1, the computing device 160 may belong to a user 161 who wants to request on-demand services. In some embodiments, the communication interface 110 may transmit signals to the computing device 160, and/or receive signals from the computing device 160 via the network 150.

In some embodiments, the communication interface 110 may allow one or more external devices 170, for example, one or more vehicle driver devices 170, to communicate with the processor 120 of the server 100 via the network 150, as shown in FIG. 1. The one or more vehicle driver devices 170 may be associated with one or more vehicles 171 respectively. The one or more vehicles 171 may be associated with one or more drivers (not shown) respectively. For example, a vehicle driver device 170 may belong to a driver of a respective vehicle 171. In some embodiments, the communication interface 110 may transmit signals to the one or more external devices 170 and/or receive signals from the external devices 170 via the network 150.

In some embodiments, the communication interface 110 may allow one or more vehicles 171, for example, a processing unit 173 of the vehicle 171 (as will be described with reference to FIG. 4), to communicate with the processor 120 of the server 100 via the network 150, as shown in FIG. 1. In some embodiments, the communication interface 110 may transmit signals to the one or more vehicles 171 and/or receive signals from the vehicles 171 via the network 150.

In some embodiments, the communication interface 110 may receive a plurality of requests for an on-demand service, for example, an item delivery service, from a plurality of computing devices 160 of users 161 via the network 150. In some embodiments, each of the requests for the item delivery service may include information about at least one selected item and a delivery location for the item delivery service. In some embodiments, each of the requests for the item delivery service may further include a request the one or more vehicles 171 to prepare the item, for example, a food, as an item provider. The communication interface 110 may then send the requests for the item delivery service to the processor 120.

In some embodiments, the communication interface 110 may receive information about locations of the computing devices 160 from the computing devices 160 via the network 150. For example, the delivery location for the item delivery service may be the location of the computing device 160. The communication interface 110 may then send the information about the location of the computing device 160 to the processor 120. As another example, the delivery location may be another location that the user 161 selects for the delivery.

The processor 120 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 120.

In some embodiments, the processor 120 may be connectable to the communication interface 110. In some embodiments, the processor 120 may be arranged in data or signal communication with the communication interface 110 to receive the request for the item delivery service.

In some embodiments, the processor 120 may segment the requests into one or more batches based on time relating to each of the requests. In some embodiments, the processor 120 may check the time relating to each of the requests. For example, the time relating to each of the requests may include at least one of: time of receipt of the request, time of placement of the request, and requested delivery time. In some embodiments, each of the requests may belong to one of the one or more batches by the processor 120.

In some embodiments, the processor 120 may segment the requests into the one or more batches based on a predetermined time slot to which the time relating to each of the requests belongs. In some embodiments, the processor 120 may determine the predetermined time slot. For example, the processor 120 may determine the predetermined time slot based on historical data about the requests for the item delivery service. For example, the historical data about the requests for the item delivery service may relate to past requests for the item delivery service made during a predetermined duration (for example, last 7 days). As an example, the historical data about the requests for the item delivery service may include, but is not limited to, a previous time slot which was measured, a number of the requests, a frequency of the requests placed throughout a day, selected items in the requests, and delivery locations of the requests. For example, the processor 120 may determine the predetermined time slot as 30 minutes, and segment the requests received in first 30 minutes into a first batch, and the requests received in next 30 minutes into a second batch.

In some embodiments, the processor 120 may update the predetermined time slot. In some embodiments, the processor 120 may, after the requests belonging to the first batch are processed, update the predetermined time slot for the next batch based on a number of the requests and the vehicles' 171 performance of preparing the selected item. For example, if the number of new requests received in next 30 minutes is greater than a predetermined number or if a ratio of increase of the new requests received in next 30 minutes is higher than a predetermined ratio, the processor 120 may shorten the predetermined time slot, for example, to 20 minutes. As another example, if the vehicles' 171 performance of preparing the selected item is above a predetermined threshold, the processor 120 may extend the predetermined time slot, for example, to 40 minutes. In this manner, the predetermined time slot may be dynamically changed to accompany at least a surge in demand and a production performance of an item preparation unit of the vehicle 171.

In some embodiments, the processor 120 may, for each of the batches, segment the requests into one or more geographical area groups based on the delivery location for each of the requests. Throughout the description, a plurality of geographical area groups may be referred to as a plurality of “islands”. For example, for the requests belonging to the first batch, the processor 120 may segment the requests belonging to the first batch into the one or more geographical area groups based on the delivery location for each of the requests. In some embodiments, the processor 120 may use the historical data about the requests for the item delivery service to segment the requests belonging to the first batch into the one or more geographical area groups based on the delivery location for each of the requests.

In some embodiments, the processor 120 may assign one or more vehicles 171 capable of preparing the selected item to the one or more geographical area groups. The assigned vehicle 171a may prepare the selected item for the item delivery service, while the assigned vehicle 17la moves along a travel route in a geographical area corresponding to the corresponding geographical area group that the vehicle 171a is assigned. In some embodiments, the processor 120 may assign the one or more vehicles 171 to the one or more geographical area groups based on at least one of a current location of the one or more vehicles 171, the vehicles' 171 capabilities of preparing item(s), and a number of requests in each of the geographical area groups. In some embodiments, the processor 120 may check a number of the one or more vehicles 171 and a number of the one or more geographical area groups, to assign the one or more vehicles 171 to the one or more geographical area groups. For example, if the number of the one or more vehicles 171 is greater than a number of the one or more geographical arca groups, the processor 120 may assign at least one vehicle 171 into each of the geographical area group. As another example, if the number of the one or more vehicles 171 is less than the number of the one or more geographical area groups, the processor 120 may assign the one or more vehicles 171 to the one or more geographical arca groups based on the number of requests in each of the one or more geographical area groups. For example, if a certain geographical area group, for example, a first geographical area group, has the smallest number of the requests compared to other geographical area groups, the processor 120 may not assign any of the one or more vehicles 171 to the first geographical area group in the first batch. As an example, the processor 120 may request a vehicle 17la assigned to an adjacent geographical area group, for example, a second geographical area group in the first batch, to cover the first geographical area group in addition to the second geographical area group that the vehicle 171a is assigned.

In some embodiments, the processor 120 may determine the travel route of the assigned vehicle 171a. For example, the assigned vehicle 171a may move along the travel route determined by the processor 120 in the geographical area corresponding to the geographical area group that the vehicle 171a is assigned. In some embodiments, the processor 120 may determine the travel route of the assigned vehicle 171a in the geographical area corresponding to the geographical arca group that the vehicle 171a is assigned, based on the delivery locations of the requests in the geographical area group. In some embodiments, a centre location where a selected delivery service provider 181a picks up the selected item from the assigned vehicle 171 a may be on the travel route of the assigned vehicle 171 (as will be described with reference to FIG. 5).

In some embodiments, the processor 120 may, for each of the geographical area groups, segment the requests into one or more clusters based on the selected item for each of the requests. For example, for a first geographical arca group in the first batch, the processor 120 may segment the requests belonging to the first geographical area group in the first batch into the one or more clusters based on the selected item for each of the requests. For example, if a first user sends a first request for the delivery service for a first item, a second user sends a second request for the delivery service for the first item, and a third user sends a third request for the delivery service for a second item which is different from the first item, the processor 120 may segment the first and the second requests into a first cluster and the third request into a second cluster. In some embodiments, the processor 120 may, for each of the geographical area groups, assign the one or more vehicles 171 to the one or more clusters based on the vehicles' 171 capabilities of preparing the selected item. For example, the processor 120 may assign a first vehicle 171a capable of preparing the first item to the first cluster and a second vehicle 171b capable of preparing the second item to the second cluster, so that the first vehicle 171a prepares the first item while the first vehicle 171a and the second vehicle 171b move in a first geographical area corresponding to the first geographical area group.

In some embodiments, the processor 120 may use the historical data about the request for the item delivery service within a certain area, for example, within a city, and the delivery location in the city, to segregate the plurality of requests into the one or more geographical area groups. For the segregation of the plurality of requests into the one or more geographical arca groups, the processor 120 may use at least one of a traditional clustering algorithm and a custom organizational specific clustering algorithm. For example, the processor 120 may use either the traditional clustering algorithm or the custom organizational specific clustering algorithm. The one or more geographical area groups may be mutually exclusive from one another and may be processed separately. In addition, the processor 120 may generate one or more clusters for different items. In some embodiments, although spatial orientation of the clusters overlaps geographically, they may be processed independently. In some embodiments, if a vehicle 171 can prepare a plurality of different items, the vehicle 171 may be used for order fulfilment of the plurality of different items without impacting other vehicles. For example, the processor 120 may add order fulfilment time of one item into preparation time of other items while processing of batch orders.

In some embodiments, the processor 120 may, for each of the geographical area groups, select a delivery service provider 181a from one or more delivery service providers 181 based on at least one of a geographical location of the delivery service provider 181a, the geographical location of the assigned vehicle 171a and the delivery location. For example, the processor 120 may select the delivery service provider 181a to minimize the overall time of delivery. In some embodiments, the processor 120 may request the selected delivery service provider 181a to pick up the selected item at the centre location (as will be described with reference to FIG. 5) on the travel route of the assigned vehicle 171a, and deliver the selected item to the delivery location.

In some embodiments, the processor 120 may determine a travel route of the selected delivery service provider 181a. In some embodiments, the processor 120 may determine the travel route of the selected delivery service provider 181a, based on at least one of the geographical location of the selected delivery service provider 181a, the geographical location of the assigned vehicle 171a, the centre location, and the delivery location. For example, the geographical location of the assigned vehicle 171a and/or the geographical location of the selected delivery service provider 181a may be changed in real-time, and the processor 120 may use the changed geographical location(s) to determine/update the travel route of the selected delivery service provider 181a. For example, the selected delivery service provider 181a may move along the travel route determined by the processor 120 to pick up the selected item at the centre location and deliver the selected item to the delivery location.

In some embodiments, the processor 120 may determine the centre location where the assigned vehicle 171a and the selected delivery service provider 181a meet so that the selected delivery service provider 181a picks up the selected item. In some embodiments, the processor 120 may determine the centre location on the travel route of the assigned vehicle, based on delivery locations for each of the requests belonging to the geographical area group. In some embodiments, the processor 120 may determine the centre location, further based on at least one of the geographical location of the selected delivery service provider 181a and the geographical location of the assigned vehicle 171a. For example, the geographical location of the assigned vehicle 171a and/or the geographical location of the selected delivery service provider 181a may be changed in real-time, and the processor 120 may use the changed geographical location(s) to determine/update the centre location.

In some embodiments, the processor 120 may determine an initial location from which the assigned vehicle 171a starts traveling based on the geographical location of the assigned vehicle 171a and the delivery location in the geographical area corresponding to the geographical area group that the vehicle 171a is assigned, in the first batch. In some embodiments, for the next batch, the processor 120 may determine an initial location from which the assigned vehicle 171a starts traveling based on the geographical location of the assigned vehicle 171a and the delivery location in the geographical area corresponding to the geographical area group that the vehicle 171a is assigned in the next batch. In some other embodiments, the last geographical location of the vehicle 171a in a previous batch, for example, the first batch, may be the initial location from which the assigned vehicle 171a starts traveling in the next batch.

In some embodiments, the processor 120 may, after a predetermined time for processing the requests belonging to the previous batch, check if the previous batch includes at least one request which is not processed. In some embodiments, if the previous batch includes at least one request which is not processed, the processor 120 may include the request which is not processed in the previous batch into the next batch of the requests.

In some embodiments, the processor 120 may generate a first priority queue of the one or more geographical area groups, for example, based on custom priority parameters, to measure the priority among the one or more geographical area groups in order to minimize the duration between the placement of the request and the final delivery in the batch among the one or more geographical area groups. In some embodiments, the processor 120 may generate a second priority queue to maintain the priority of the item preparation units of the vehicles 171 to receive the requests from the one or more geographical area groups, for the balance of the individual units' demand and supply. In some embodiments, the processor 120 may generate a third priority queue to maintain the priority among the delivery service providers 181 to optimise the difference in the overall deliveries made by each delivery service provider through this procedure.

As described above, in accordance with various embodiments, the server 100 may achieve a delivery of an item, for example, a perishable goods in a quick and efficient manner, before the goods perishes. Therefore, the users 161 may receive the item, for example, the perishable goods, in a fresh state. In some embodiments, the server 100 may be a centralised server which may communicate with the users 161, the vehicles 171 and the delivery service providers 181 and may orchestrate processes of the delivery of the perishable goods in a quick and efficient manner.

In addition, as described above, according to the various embodiments, the server 100 may observe a surge in demand of the item delivery, using the historical data about the request for the item delivery service. Therefore, the server 100 may accurately derive estimated time of the delivery of the item using the observation.

FIG. 3 illustrates a flow diagram for a method for processing on-demand services according to various embodiments. According to various embodiments, the method 300 for processing the on-demand services may be provided.

In some embodiments, method 300 may include a step 301 of receiving a plurality of requests for an item delivery service. In some embodiments, each of the plurality of requests may include information about at least one selected item and a delivery location for the item delivery service.

In some embodiments, method 300 may include a step 302 of segmenting the requests into one or more batches based on time relating to each of the requests.

In some embodiments, method 300 may include a step 303 of, for each of the batches, segmenting the requests into one or more geographical area groups based on the delivery location for each of the requests.

In some embodiments, method 300 may include a step 304 of assigning one or more vehicles capable of preparing the selected item to the one or more geographical area groups. In some embodiments, the assigned vehicle may prepare the selected item for the item delivery service, while the assigned vehicle moves along a travel route in a geographical area corresponding to the corresponding geographical area group that the vehicle is assigned.

FIG. 4 illustrates a block diagram of a vehicle 171 for processing on-demand services according to various embodiments.

In some embodiments, the vehicle 171 may include, but is not limited to, an item preparation unit 172, a processing unit 173, a driving unit 174, and a storage unit 175.

In some embodiments, the item preparation unit 172 may create the item. For example, the item preparation unit 172 may prepare the item. For example, the item preparation unit 172 may produce and/or manufacture the item. In some embodiments, the item preparation unit 172 may be an encapsulated item preparation unit 172 with a custom assembly line of items. In some embodiments, the vehicle 171 may include a plurality of item preparation units 172 which, for example, may be isolated not only from one another but also from the driving unit 174. In some embodiments, the vehicle 171 may include a plurality of item preparation units 172 which may be referred to as intra-dependent item preparation units, and at least one of the item preparation units 172 may prepare an intermediate item which may be assembled into a new (final) item.

In some embodiments, the item preparation unit 172 may be in a size, for example, a small size, such that the item preparation unit 172 may be mounted on the vehicle 171, for example, a truck or an automobile. In some embodiments, a size of the vehicle 171 may be directly proportional to a size of the item preparation unit 172. For example, the item preparation unit 172 may be mounted on top of the vehicle 171. As another example, the item preparation unit 172 may be mounted inside the vehicle 171.

In some embodiments, the item preparation unit 172 may prepare one kind of item. In some other embodiments, the item preparation unit 172 may prepare multiple kinds of items (i.e. different kinds of items). In some embodiments, the item preparation unit 172 may use raw materials to prepare the item. In some embodiments, the raw materials may be in a size, for example, a small size, such that the raw materials may be loaded into the vehicle 171.

In some embodiments, the item preparation unit 172 may be independent of the driving unit 174 of the vehicle 171, and the server 100 shown in FIG. 1 may be used to orchestrate a rate of the preparation of the item and the placement of the request.

In some embodiments, the driving unit 174 may control the vehicle 171 to move. In some embodiments, the driving unit 174 may control the vehicle 171 to move along a travel route determined by the server 100.

In some embodiments, the storage unit 175 may temporarily place the items prepared by the item preparation unit 172, from time of the preparation to time of delivering to a selected delivery service provider.

In some embodiments, the processing unit 173 may process the item. For example, the processing unit may modify, pack, and/or ready the item for the delivery. For example, the processing unit 173 may process the item created by the item preparation unit 172. As another example, the processing unit 173 may process a finished item, without the need for the item preparation unit 172 to create the item. In some embodiments, the processing unit 173 may communicate with the server 100 via a communication unit (not shown) of the vehicle 171. In some other embodiments, the item preparation unit 172 and the driving unit 174 may include a processor respectively, which may be used to communicate with the server 100. In some embodiments, the vehicle 171 may receive instructions from the server 100 such that a successful item delivery may be made upon the vehicle 171 reaching an instructed geographical location, for example, a centre location.

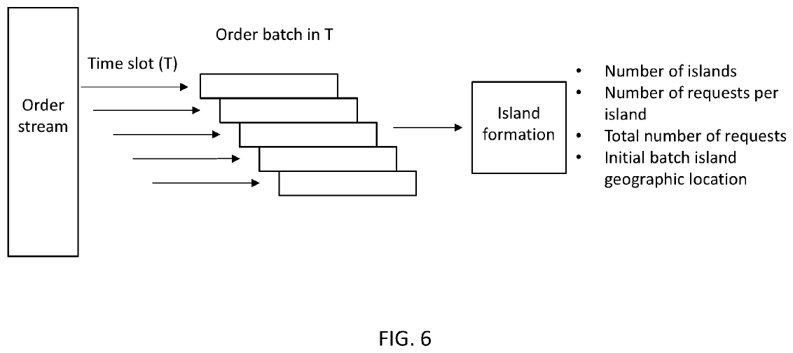

FIG. 5 illustrates a flow diagram for a method 400 for processing on-demand services according to various embodiments. According to various embodiments, the method 400 for processing the on-demand services may be provided. FIG. 6 illustrates an exemplary diagram of tabulating data for an entire request stream, with reference to a step 401 of the method 400. In some embodiments, an item preparation unit 172 and/or a processing unit 173 as described with reference to FIG. 4 may be used to prepare an item. Which unit to use may depend on the item. As an example, an item which may not require packing may be solely prepared by the item preparation unit 172. As another example, an item which may be a finished item may be solely prepared by the processing unit 173. As another example, an item which may need to be created from raw materials and subsequently packed may be prepared by the item preparation unit 172 and the processing unit 173.

In some embodiments, the method 400 may include the step 401 of initial data processing of historical data about the requests for the item delivery service (also referred to as “historical data” or “historical orders data”).

In some embodiments, the server 100 shown in FIG. 1 may use the historical data about the requests for the item delivery service. In some embodiments, the server 100 may partition the historical data based on at least one of the item ordered, the delivery location, the time relating to the request (for example, the time of placement of the request for each item).

In some embodiments, the requests for each item may be mutually exclusive from one another and may be processed separately. The plurality of requests may be segregated into the one or more geographical area groups. The server 100 may use at least one of a traditional clustering algorithm and a custom organizational specific clustering algorithm for the segregation of the plurality of requests into the one or more geographical area groups. The one or more geographical arca groups may be mutually exclusive from one another and may be processed separately. In some embodiments, there may be two or more geographical area groups which are overlapped in terms of a selected item, for example, a first geographical area group requesting a first item and a second geographical area group requesting a second item, and a vehicle including an item preparation unit and/or a processing unit capable of preparing both the first and second items may be involved in the delivery of the first and second items in the first and second geographical area groups.

In some embodiments, the server 100 may consider the historical data about the requests for the item deliver service (also referred to as “order stream data” or “historical order stream data”). The server 100 may use the entire order stream data to decide whether providing the item in accordance with various embodiments of the invention may be profitable. The server 100 may observe the profitability based on at least one of a frequency of the requests placed throughout a day and certain custom parameters defined by an organisation who uses or wishes to use the server 100. The server 100 may use the entire order stream data to identify time intervals of a day at which implementing the various embodiments of the invention is profitable.

As shown in FIG. 6, in some embodiments, the server 100 may batch the historical order stream data with a predefined time interval (T) (also referred to as a “predetermined time slot”). The batched requests in that time interval (T) may be observed and then segmented into one or more geographical area groups based on the delivery locations of the requests. In some embodiments, there may be a plurality of geographical area groups (also referred to as “a plurality of islands”) of the delivery locations. In some other embodiments, there may be sparsely distributed delivery locations (for example, one geographical area group). Both embodiments may be processed in different ways. For example, the plurality of islands formed may be defined for the time interval (T) (i.e. a previous batch), and order stream batched in a next time interval may form islands which may be completely different from those formed in the previous batch. In some embodiments, the plurality of islands from a previous batch may overlap with a plurality of islands of a current batch. In some embodiments, the time interval (T) may be varied. For example, at least one of a number of islands, a number of orders per island, a total number of orders in the time interval (T), a map of islands, and an initial batch island geographical location may be tabulated/used, to determine the next time interval. In some embodiments, geographical locations of all the islands formed in the first batch may be tabulated/used/updated (for example, in real-time) as an initial location for the vehicles 171 to start their transit.

In some embodiments, the method 400 may include a step 402 of initial data processing about a vehicle functionality.

In some embodiments, for every item preparation unit and/or every processing unit registered to provide the items according to various embodiments of the invention, the server 100 may estimate and tabulate production time of each item based on batch production. It may be appreciated that time taken to produce a couple of the same items is less than double of producing the same item once. In some embodiments, production time table entries may vary with different item preparation unit and/or different processing unit, and thus the production time for the item preparation units and/or processing units may be tabulated and updated in a predetermined time interval, for example, frequently or in a real-time, for the accuracy of the estimations. In some embodiments, average production time of the item may be tabulated and updated, when real-time stream data is processed when the vehicle is in transit.

In some embodiments, if the vehicle includes a plurality of item preparation units and/or a plurality of processing units, each of the plurality of item preparation units and/or the plurality of processing units may have its own tabulated production time of its item. In some embodiments, intra-dependent item preparation units may have production time of a final assembled item, rather than a table for each intermediate item. In some embodiments, if a new item preparation unit and/or a new processing unit is to be onboarded into a vehicle providing the item, the production time of the item by the new item preparation unit and/or the new processing unit may be tabulated.

In some embodiments, the method 400 may include a step 403 of dynamic order stream processing by batch.

In some embodiments, a production capacity of the item preparation unit and/or the processing unit may be defined as a total number of items that the item preparation unit and/or the processing unit can produce on that day. The production capacity of the item preparation unit may be evaluated based on available raw materials for the production of the item. For the item preparation unit, the production capacity may be dynamic in nature and vary (either increase or decrease) throughout a day, while production time of the item may be comparatively constant.

In some embodiments, at a beginning of the order stream, a production time data table and historical order stream processing tables for each of the item preparation units and/or the processing units may be decided, for example, based on a time slot duration at which the historical total number of the requests in a region is close to a total number of items produced by the available item preparation units and/or the available processing units in the same time period. For example, the time slot duration may be calculated mathematically or obtained by plotting them graphically.

Similarly, in some embodiments, an initial location of the item preparation unit and/or the processing units may be determined by using the historical order stream data. The historical order stream data may be batched with a predetermined time slot which is obtained from the production time data table and the historical order stream processing tables for each of the item preparation units and/or the processing units. The vehicles may be directed to kickstart from islands generated from the historical order stream data.

In some embodiments, if the number of islands is greater than the number of the item preparation units and/or the processing units, the server 100 may select the island(s) having more orders. In some other embodiments, if the number of the item preparation units and/or the processing units is greater than the number of islands, the item preparation unit and/or the processing unit may be evenly divided among the islands predicted.

In some embodiments, after the initial setup, when the order stream inflow begins, the requests placed in the predetermined time slot may be batched. Meanwhile, the available item preparation units and/or the available processing units may be tasked to produce a part of the items, for example, a half of the items, according to the requests placed as noted in the historical order stream data. At the end of the predetermined time slot, following operations may be triggered sequentially.
1) The islands may be observed and noted.
2) At least one newly generated island may be added to an island delivery priority queue. The island delivery priority queue may be updated for an optimal delivery (as will be described below with reference to a step 404 of FIG. 5).
3) Ordering of the item preparation unit and/or the processing unit with respect to priority parameters (as will be described below with reference to a step 405 of FIG. 5)
4) Pinpointing of location of item exchange between the vehicle and a delivery service provider (as will be described below with reference to a step 406 of FIG. 5)
5) The item preparation units and/or the processing units are mapped to islands (as will be described below with reference to a step 407 of FIG. 5).
6) The number of items assigned to the item preparation unit and/or the processing unit (as will be described below with reference to a step 408 of FIG. 5)
7) Next order stream batch accumulation may be triggered.
8) Dynamic update of the predetermined time slot may be triggered (as will be described below with reference to a step 409 of FIG. 5).
9) The delivery service provider mapping to the vehicle (as will be described below with reference to a step 410 of FIG. 5)

In some embodiments, all the above-mentioned tasks may occur sequentially and be repeated for every order stream batch. In some embodiments, an island density in the region, an item preparation unit's and/or a processing unit's production capacity, and the predetermined time slot may be updated every time as each batch is processed. As each batch is processed, an algorithm may be devised to optimally map the islands to the item preparation units and/or the processing units, assign the number of items to the item preparation unit and/or the processing unit, update the predetermined time slot of order stream batch, and map the delivery service provider to the vehicle (in which the item preparation unit and/or the processing unit assigned for the production of the item is mounted) for the exchange of the item at a location, for example, a centre location, such that the demand and supply or the request is met with an optimal load on each item preparation unit and/or the processing unit based on its current production capacity.

In some embodiments, the method 400 may include a step 404 of island queue formation.

In some embodiments, at the end of the predetermined time slot generated, island(s) may be added to the island priority queue based on a priority described below. In some embodiments, at the start of the order stream, the island priority queue may be empty, and as the order stream is processed, the island(s) may be added at the end of the predetermined time slot. In some embodiments, if there is at least one request which is not processed during a previous time slot, the request which is not processed may be carried forward along with newly created islands of a current time slot. In some embodiments, the processed islands in the previous time slot may be discarded from the island priority queue. The priority of each island priority queue item may be weighted average of the following parameters:
1) The number of requests in the island
2) The number of individual items ordered in the island
3) The island creation time Customized parameters which may be fit by the organization may be included in determining the priority in the island queue. The weights of each parameter may define the prioritized parameters in island order processing, and the weights may be customized differently to obtain different organizational requirements.

In some embodiments, the method 400 may include a step 405 of ordering of the item preparation unit and/or the processing unit with respect to priority parameters for data structure formation.

In some embodiments, the ordering of the item preparation units and/or the processing units may be done to generate a priority among the item preparation units and/or the processing units within the region. This ordering may be used to assign the item preparation units and/or the processing units to islands. The ordering among the item preparation units and/or the processing units may be generated using the weighted average of the following parameters.
1) The total number of requests the item preparation unit and/or the processing units has delivery on that day
2) The latency of the vehicle in performing the item exchange with the delivery service provider
3) The production time of the item by the item preparation unit and/or the processing unit
4) Current items in a storage component of the item preparation unit, the processing unit and/or a storage unit of the vehicle
5) Time to live of the items in the storage component of the item preparation unit, the processing unit and/or the storage unit of the vehicle
6) Idle time of a production component of the item preparation unit and/or the processing unit

Customized parameters which may be fit by the organization may be included in determining the ordering of the item preparation units and/or the processing units. The weights of each parameter may define the prioritized parameters in ordering of the item preparation units and/or the processing units, and the weights may be customized differently to obtain different organizational requirements.

In some embodiments, the item preparation unit and/or the processing unit having relatively more idle time of the production component and relatively fewer number of requests delivered on that day with respect to its item production capacity may be more prioritized, compared to other item preparation units and/or the processing units, and appropriate weights may be adjusted to generate custom priority outcomes.

In some embodiments, after the end of the item exchange to the delivery service provider, a data structure of the ordering of the item preparation unit and/or the processing unit may be updated with respect to its updated priority values, and thus the item preparation unit and/or the processing unit may be assigned to a new island with the updated priority values.

In some embodiments, the method 400 may include a step 406 of pinpointing a location of the item exchange between the vehicle and the delivery service provider.

In some embodiments, the identified islands may be processed individually.

In some embodiments, if the delivery locations are sparsely spread across the island, the server 100 may consider a fully connected graph with the delivery locations as vertices and the delivery service providers' real-time street travel time between two vertices as the respective edge weight. The server 100 may use a traveling salesman algorithm to cover all the vertices and choose a resultant vertex as a central location of the island.

In some other embodiments, if the delivery locations are segmented into a plurality of islands, for each island, the delivery location in the island may be clustered based on at least one of a traditional existing clustering algorithm with street distance as a parameter of clustering or a custom designed algorithm based on custom parameters, and the centre location of the island may be identified accordingly.

In some embodiments, the centre location of the island may not be finalised as a point of delivery. In some embodiments, the centre location of the island may be changed based on availability of the item preparation units and/or the processing units in a vicinity of the island.

In some embodiments, the method 400 may include a step 407 of mapping the item preparation units and/or the processing units to the islands.

In some embodiments, just before the end of each time slot, the processing unit may update the number of items that it currently possesses in its storage compartment or the storage unit after making a successful delivery to a respective delivery service provider in the previous time slot, based on the current item availability in the processing unit, production time of the item of the item preparation unit and/or the processing unit, a real time location of the vehicle, and the total number of items that the item preparation unit and/or the processing unit can produce by the time the vehicle reaches all the islands' centre locations.

In some embodiments, after the predetermined time slot, the requests may be accumulated and segregated into islands. Each island from the island priority queue may be mapped to one or more item preparation units and/or processing units based on the following process.

If the organization favours certain item preparation units and/or processing units (for example, the organization's own item preparation units and/or processing units), the island priority queue of the item preparation units and/or the processing units in the region may be generated based on custom priority parameters, and an item preparation unit and/or a processing unit having a high priority may be mapped to an island having a high priority in the island priority queue. An island order demand may be reduced by the quantity equal to the predicted requests produced by the time the item preparation unit and/or the processing unit reaches the centre location of the island, and the item preparation unit priority queue and/or the processing unit priority queue may be updated by removing the assigned item preparation unit and/or processing unit. If the island still has items to be delivered, the next most prioritized item preparation unit and/or processing unit may be assigned. These steps may be repeated until the island's requests are processed and until either the island priority queue or the item preparation unit priority queue and/or the processing unit priority queue is empty. The non-empty queue elements may be added as a backlog element to the respective queue in the next time slot data.

In some other embodiments, if the organization is equally opportunistic to all its registered item preparation units and/or processing units, a binary search tree of the item preparation units and/or the processing units in the region may be generated based on custom ordering parameters. The binary search tree may be processed in a way such that an order demand of the island having the high priority is met with the lowest number of the item preparation units and/or processing units that can provide the items of the island, and the process may be continued until either the island priority queue or the item preparation unit binary search tree and/or the processing unit binary search tree is empty. The non-empty elements may be added as a backlog element to the respective data structure in the next time slot data. There may be a scenario where an island's demand can only be partially met. Those partial island's remaining requests may be forwarded to be processed in the next time slot.

In some embodiments, the data structuring of both islands and item preparation units and/or processing units may not be limited to the above description. Custom data structures providing a relative priority among the islands and respective relative priority/ordering among the item preparation units and/or the processing units may be used with relevant updating algorithms to respective data structures.

In some embodiments, the method 400 may include a step 408 of determining the number of products assigned to the item preparation unit and/or the processing unit.

In some embodiments, if only one item preparation unit and/or processing unit is assigned to an island, a demand of producing items for all the requests may be assigned to the item preparation unit and/or the processing unit, and the items may be picked up by the delivery service provider at the centre location of the island.

In some embodiments, for a scenario of sparse delivery locations, when more than one item preparation unit and/or processing unit is added, the delivery locations of the requests may further be segregated based on the total requests in the segregation, and each segregation may be processed using the traveling salesman algorithm to identify an optimal location of the item exchange between the vehicle and the delivery service provider.

In some embodiments, for the scenario of clusters formed within the region, each cluster may be handled separately and a fraction of item preparation units and/or processing units may be assigned to a particular cluster based on the predicted item production of the item preparation unit and/or the processing unit and demand of the cluster.

In some embodiments, the time to live of the item, item production time of individual item preparation units and/or processing units, current items in the storage component of the item preparation unit and/or the processing unit, and other custom parameters may be considered and an optimal number of requests may be assigned to every item preparation unit and/or processing unit for production and exchange with the delivery service provider. In some embodiments, the logic behind the assignment may be customized based on the organization priorities.

In some embodiments, the method 400 may include a step 409 of dynamic update of the predetermined time slot.

In some embodiments, if an order frequency in a region is relatively less than a combined production rate of all the item preparation units and/or the processing units in the region, the next (subsequent) time slot may be increased so as to increase the demand compared to the supply of that item. In some embodiments, if the order frequency is more than the combined production rate of all the item preparation units and/or the processing units, the next time slot may be progressively decreased to meet the supply and demand of that item. There may be a scenario for freezing the order stream in order to avoid overloading the item preparation units and/or the processing units.

In some embodiments, the method 400 may include a step 410 of mapping the delivery service provider to the vehicle.

In some embodiments, an ordering of the delivery service providers may be generated to provide an equal opportunity to all the delivery service providers in the region. This step may be customized to provide an advantage to specific delivery service providers. A typical priority queue of the delivery service providers may be implemented, and the delivery service providers with the highest priority may be assigned to a vehicle having an item preparation unit and/or a processing unit with the most delivery item exchange, The priority parameters of the delivery service providers may be customized as weighted average of the following parameters:
1) The number of successful deliveries made on that day
2) The latency of delivery when compared to predicted delivery time
3) The customer feedback on the delivery service provider
4) Goodwill of the delivery service provider in correlation with the organization

Customized parameters which may be fit by the organization may be included in determining the ordering of the delivery service providers. The weights of each parameter may define the prioritized parameters in ordering of the delivery service providers, and the weights may be customized differently to obtain different organizational requirements.

In some embodiments, the method 400 may include a step 411 of improving designed system parameters using machine learning models.

In some embodiments, the weights of the parameters defined above may not only be defined manually to prioritize as per organization specifications but also be used to train an artificial neural network to maximize the profitability of the designed system 200. The proper construction of the network using the above defined parameters may generate a proper configuration of the weights of these parameters for better profitability.

The various embodiments of the invention may also be extended to generate the weights for low latency delivery or reduction in a rejection of a request due to expiry of the item.

Furthermore, the various embodiments of the invention may be used for delivery of items not only within a city, but also to make a successful intercity order delivery, and these cities need not be in the same country. The order delivery can may be achieved with intermediate items processed in separate countries while in transit, and the intermediate items may be in turn assembled before reaching its final delivery location.

The various embodiments of the invention may not only be limited to early perishable goods but also may be extended to finished items as well with an implicit change in time to live weightage to zero. The various embodiments of the invention may adjust relevant weights in the evaluation of priority for ordering of islands, processing units and delivery service provider data structures.

The various embodiments of the invention may be extended by replacing the processing unit on road connectivity with either a rail network connectivity or an aerial drone network or even a cargo ship network. The respective parameters along with their proper weights may be adjusted as per the mode of mobility.

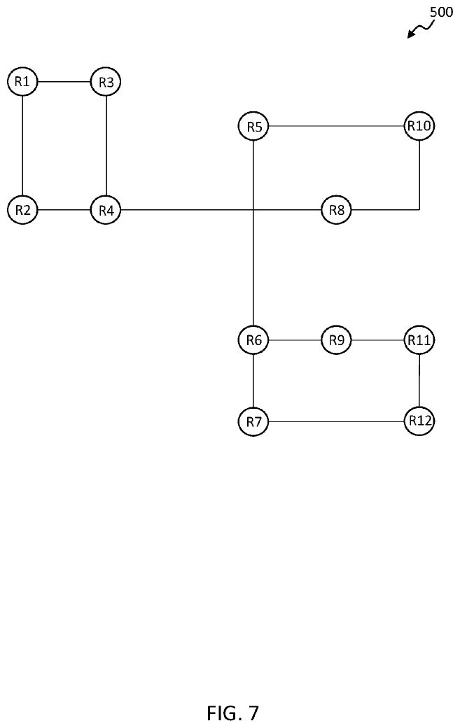

FIGS. 7 to 11 illustrate exemplary diagrams of segmenting requests for an on-demand service into one or more geographical arca groups, according to various embodiments.

FIG. 7 illustrates an example of a road network graph 500. As shown in FIG. 7, the server 100 may receive a plurality of requests for the item delivery service (R1 to R12) during a predetermined time slot. In the road network graph 500, the delivery locations of each of the requests (R1 to R12) are indicated as “R1 to R12”. The server 100 may batch the requests (R1 to R12). For example, the server 100 may segment the requests (R1 to R12) received during the predetermined time slot into a first batch. In some embodiments, the predetermined time slot for the first batch may be determined based on historical data about the requests for the item delivery service.

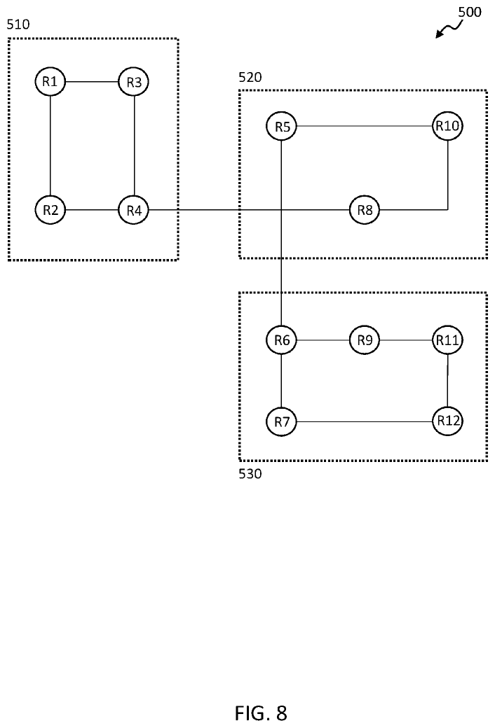

As shown in FIG. 8, for each of the batches, for example, the first batch, the server 100 may segment the requests (R1 to R12) into one or more geographical area groups 510, 520, 530 based on the delivery location for each of the requests (R1 to R12). For example, a first request (R1), a second request (R2), a third request (R3) and a fourth request (R4) may be assigned to a first geographical area group 510. A fifth request (R5), an eighth request (R8) and a tenth request (R10) may be assigned to a second geographical arca group 520. A sixth request (R6), a seventh request (R7), a ninth request (R9), an eleventh request (R11) and a twelfth request (R12) may be assigned to a third geographical area group 530.

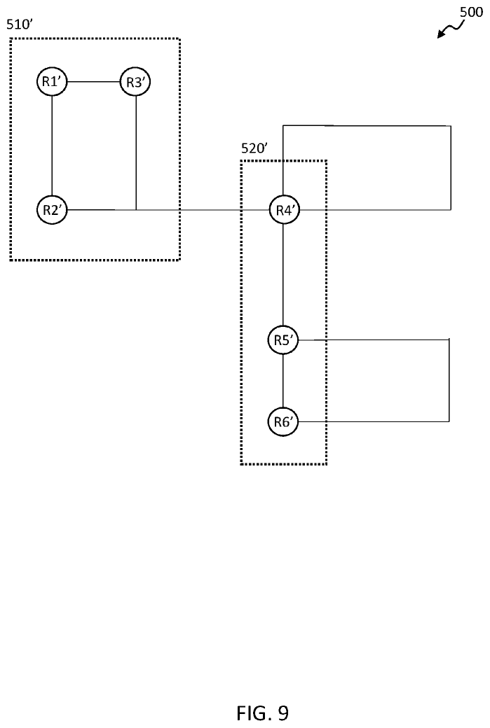

As shown in FIG. 9, the requests in the first batch may be processed, and new requests for the item delivery service may be received. As shown in FIG. 9, the server 100 may receive a plurality of (new) requests for the item delivery service (R1′ to R6′) during a next predetermined time slot. The server 100 may batch the requests (R1′ to R6′). For example, the server 100 may segment the requests (R1′ to R6′) received during the next predetermined time slot into a next (second) batch. In some embodiments, the next predetermined time slot may be the same as the predetermined time slot for the first batch. In some other embodiments, the next predetermined time slot may be different from the predetermined time slot for the first batch. The next predetermined time slot may be determined based on a number of the requests and the vehicles' performance of preparing the selected item.

As shown in FIG. 9, for the second batch, the server 100 may segment the requests (R1′ to R6′) into one or more geographical area groups 510′, 520′ based on the delivery location for each of the requests (R1′ to R6′). As shown in FIG. 9, the number of the geographical area groups and/or the area covered by each of the geographical area groups for the next (second) batch may be different from the those of the first batch. For example, a first request (R1′), a second request (R2′), and a third request (R3′) may be assigned to a first geographical area group 510′ in the second batch. A fourth request (R4′), a fifth request (R5′), and a sixth request (R6′) may be assigned to a second geographical area group 520′ in the second batch.

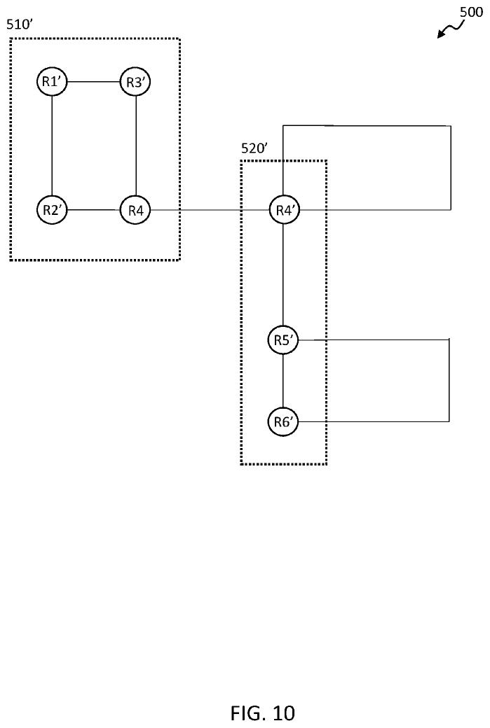

As shown in FIG. 10, after a predetermined time for processing the requests belonging to the previous batch, for example, the first batch, the server 100 may check if the first batch includes at least one request which is not processed. The server 100 may include the request which is not processed in the first batch into the next batch of the requests. For example, the fourth request (R4) may not be processed in the first batch. The server 100 may include the fourth request (R4) which is not processed in the first batch into the next batch of the requests (R1′ to R6′). For example, the server 100 may assign the fourth request (R4) to the new first geographical area group 510′, based on the delivery location of the fourth request (R4).

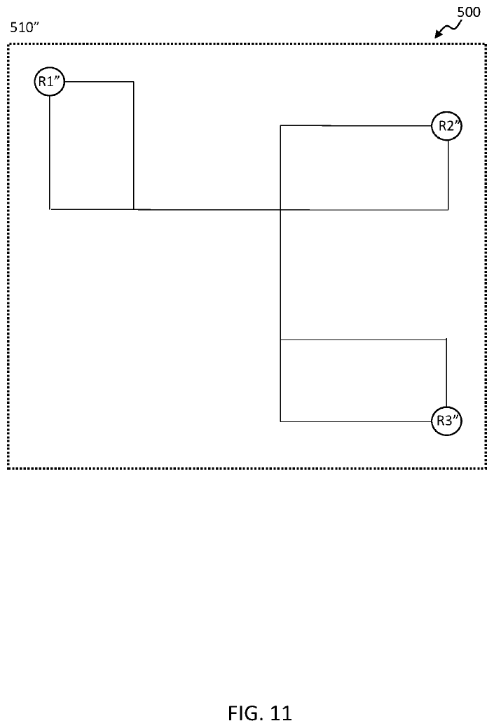

As shown in FIG. 11, there may be sparsely distributed delivery locations. For example, the server 100 may receive a plurality of (new) requests for the item delivery service (R1″ to R3″). Based on the delivery locations of the requests (R1″ to R3″), the server 100 may determine that the delivery locations of the requests (R1″ to R3″) are sparsely distributed. The server 100 may use one geographical area group 510″ covering the requests (R1″ to R3″).

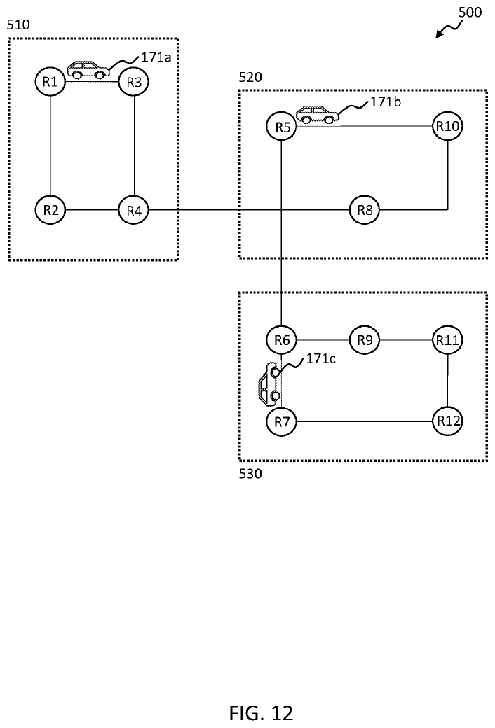

FIGS. 12 to 15 illustrate exemplary diagrams of assigning vehicles to one or more geographical area groups, according to various embodiments.

In some embodiments, the server 100 may check the number of the one or more vehicles 171 and the number of the one or more geographical area groups, to assign the one or more vehicles 171 to the one or more geographical area groups.

As shown in FIG. 12, if the number of the one or more vehicles 171 is the same as the number of the one or more geographical area groups 510, 520, 530, the server 100 may assign each vehicle 171 into each of the geographical area group 510, 520, 530. For example, the server 100 may assign a first vehicle 171a to a first geographical area group 510, a second vehicle 171b to a second geographical arca group 520, and a third vehicle 171e to a third geographical area group 530.

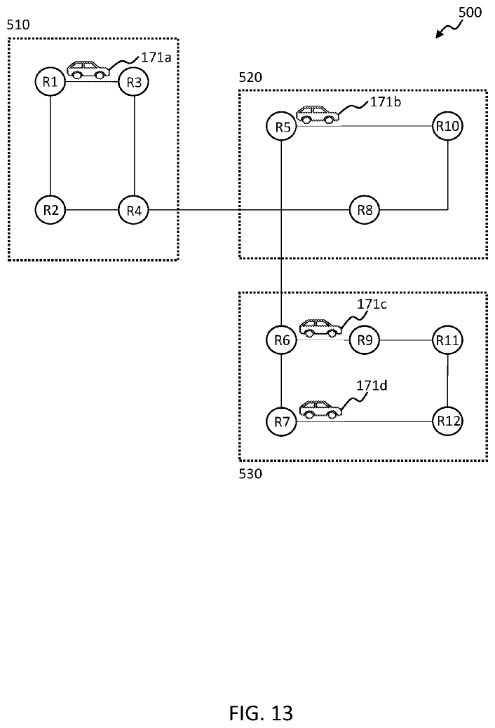

As shown in FIG. 13, if the number of the one or more vehicles 171 is greater than a number of the one or more geographical arca groups 510, 520, 530, the server 100 may assign at least one vehicle 171 into each of the geographical area group 510, 520, 530 based on the number of orders (also referred to as “order counts”) in each of the one or more geographical area groups 510, 520, 530. For example, the server 100 may assign the first vehicle 171a to the first geographical area group 510, the second vehicle 171b to the second geographical area group 520, and the third vehicle 171c and the fourth vehicle 171d to the third geographical area group 530 having the highest number of orders.

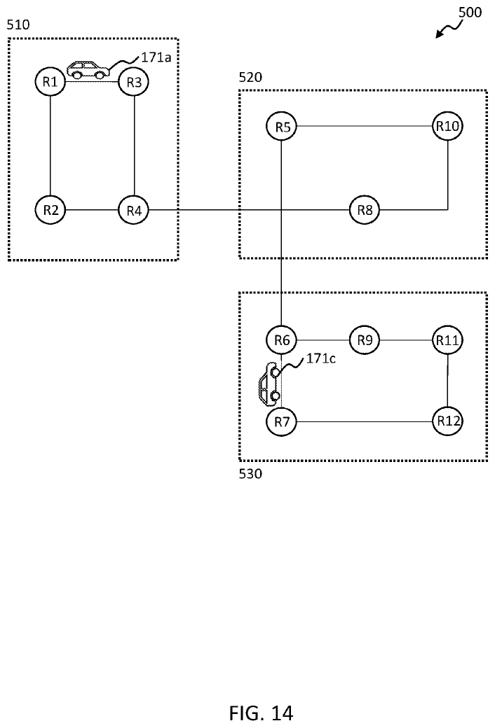

As shown in FIG. 14, if the number of the one or more vehicles 171 is less than a number of the one or more geographical area groups 510, 520, 530, the server 100 may assign the vehicle 171 to a part of the geographical area groups 510, 530 based on the number of orders in each of the one or more geographical area groups 510, 520, 530. For example, the server 100 may assign the first vehicle 171a to the first geographical area group 510, and the second vehicle 171b to the third geographical area group 530, and may not assign the vehicle to the second geographical area groups 520 having the fewest number of orders.

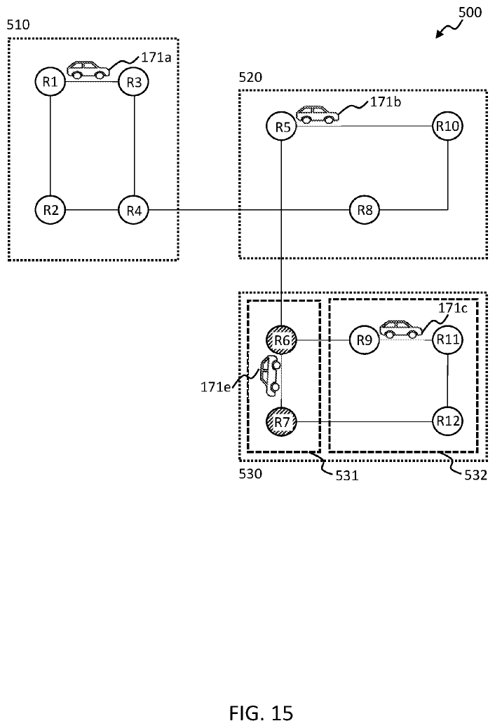

In some embodiments, the server 100 may, for each of the geographical arca groups, segment the requests into one or more clusters based on the selected item for each of the requests. As shown in FIG. 15, if the ninth request (R9), the eleventh request (R11) and the twelfth request (R12) relate to a delivery of the first item and the sixth request (R6) and the seventh request (R7) relate to a delivery of the second item, the server 100 may segment the requests (R6, R7, R9, R11, R12) in the third geographical area group 530 into two clusters 531, 532 based on the selected item. For example, the server 100 may assigned the sixth request (R6) and the seventh request (R7) to a first cluster 531, and the ninth request (R9), the eleventh request (R11) and the twelfth request (R12) into a second cluster 532. Thereafter, the server 100 may assign a third vehicle 171c capable of preparing the first item into the second cluster 532 of the third geographical arca group 530, and a fifth vehicle 171c capable of preparing the second item into the first cluster 531 of the third geographical area group 530.

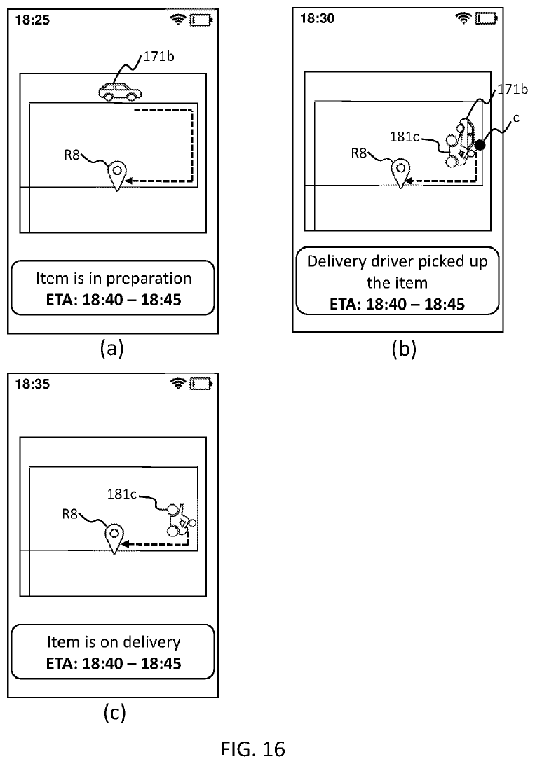

FIG. 16 illustrates exemplary diagrams of a user interface of a user's 161 computing device 160, according to various embodiments.

As shown in FIG. 16(a), when an item is in preparation, the computing device 160 may display a map indicating the delivery route. For example, the computing device 160 may display a delivery location (R8) and a location of a vehicle 171b preparing the item. The computing device 160 may further display an estimated time of arrival.

As shown in FIG. 16(b), when the delivery service provider 181c (also referred to as a “delivery driver”) picks up the item at a centre location (c), the computing device 160 may display a notification informing that the delivery service provider 181e picks up the item. The computing device 160 may display the location of the vehicle 171b and a location of the delivery service provider 181c. The computing device 160 may further display the estimated time of arrival, for example, an updated estimated time of arrival.

As shown in FIG. 16(c), when the delivery service provider 181c is on the way to deliver the item to the user 161, the computing device 160 may display a notification informing that the item is on delivery. The computing device 160 may display the location of the delivery service provider 181c. The computing device 160 may further display the estimated time of arrival, for example, an updated estimated time of arrival.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server for processing on-demand services, the server comprising:
a memory for storing instructions; and
a processor for executing the stored instructions and configured to:
receive a plurality of requests for an item delivery service, wherein each of the plurality of requests includes information about at least one selected item and a delivery location for the item delivery service;
segment the requests into one or more batches based on time relating to each of the requests;
for each of the batches, segment the requests into one or more geographical area groups based on the delivery location for each of the requests; and
assign one or more vehicles capable of preparing the selected item to the one or more geographical area groups, so that the assigned vehicle prepares the selected item for the item delivery service while the assigned vehicle moves along a travel route in a geographical area corresponding to the geographical area group that the vehicle is assigned.

2. The server according to claim 1, wherein the processor is further configured to, for each of the geographical area groups, segment the requests into one or more clusters based on the selected item for each of the requests.

3. The server according to claim 2, wherein the processor is further configured to, for each of the geographical area groups, assign the one or more vehicles to the one or more clusters based on the vehicles' capabilities of preparing the selected item.

4. The server according to claim 1, wherein the processor is further configured to:
for each of the geographical area groups, select a delivery service provider from one or more delivery service providers based on at least one of a geographical location of the delivery service provider, the geographical location of the assigned vehicle and the delivery location; and
request the selected delivery service provider to pick up the selected item at a centre location on the assigned vehicle's travel route and deliver the selected item to the delivery location.

5. The server according to claim 4, wherein the processor is further configured to determine the centre location on the travel route of the assigned vehicle, based on delivery locations for each of the requests belonging to the geographical area group.

6. The server according to claim 1, wherein the processor is further configured to segment the requests into the one or more batches based on a predetermined time slot to which the time relating to each of the requests belongs.

7. The server according to claim 6, wherein the processor is further configured to determine the predetermined time slot based on historical data about the requests for the item delivery service.

8. The server according to claim 7, wherein the processor is further configured to, after the requests belonging to a first batch are processed, update the predetermined time slot based on a number of the requests and the vehicles' performance of preparing the selected item.

9. The server according to claim 1, wherein the processor is further configured to, after a predetermined time for processing the requests belonging to a previous batch, check if the previous batch includes at least one request which is not processed; and
include the request which is not processed in the previous batch into a next batch of the requests.

10. A method for processing on-demand services, the method comprising:
receiving a plurality of requests for an item delivery service, wherein each of the plurality of requests includes information about at least one selected item and a delivery location for the item delivery service;
segmenting the requests into one or more batches based on time relating to each of the requests;
for each of the batches, segmenting the requests into one or more geographical area groups based on the delivery location for each of the requests; and
assigning one or more vehicles capable of preparing the selected item to the one or more geographical area groups, so that the assigned vehicle prepares the selected item for the item delivery service while the assigned vehicle moves along a travel route in a geographical area corresponding to the corresponding geographical area group that the vehicle is assigned.

11. The method according to claim 10 further comprising, for each of the geographical area groups, segmenting the requests into one or more clusters based on the selected item for each of the requests.

12. The method according to claim 11 further comprising, for each of the geographical area groups, assigning the one or more vehicles to the one or more clusters based on the vehicles' capabilities of preparing the selected item.

13. The method according to claim 10 further comprising:
for each of the geographical area groups, selecting a delivery service provider from one or more delivery service providers based on at least one of a geographical location of the delivery service provider, the geographical location of the assigned vehicle, and the delivery location; and
requesting the selected delivery service provider to pick up the selected item at a centre location on the assigned vehicle's travel route and deliver the selected item to the delivery location.

14. The method according to claim 13 further comprising determining the centre location on the travel route of the assigned vehicle, based on delivery locations for each of the requests belonging to the geographical area group.

15. The method according to claim 10 further comprising segmenting the requests into the one or more batches based on a predetermined time slot to which the time relating to each of the requests belongs.

16. The method according to claim 15 further comprising determining the predetermined time slot based on historical data about the requests for the item delivery service.

17. The method according to claim 16 further comprising, after the requests belonging to a first batch are processed, updating the predetermined time slot based on a number of the requests and the vehicles' performance of preparing the selected item.

18. The method according to claim 10 further comprising, after a predetermined time for processing the requests belonging to a previous batch, checking if the previous batch includes at least one request which is not processed; and
including the request which is not processed in the previous batch into a next batch of the requests.

19. A data processing apparatus configured to perform the method of claim 10.

20. A non-transitory computer-readable medium comprising program instructions, which, when executed by one or more processors, cause the one or more processors to perform the method of claim 10.
